(19) United States
(12) Patent Application Publication
(10) Pub. No.: US 2023/0156169 A1
(43) Pub. Date: May 18, 2023

(54) REDUCED BANDWIDTH IMAGE TRANSFER

(71) Applicant: Capital One Services, LLC, McLean, VA (US)

(72) Inventors: Austin Walters, Champaign, IL (US); Vincent Pham, Seattle, WA (US); Jeremy Goodsitt, Champaign, IL (US)

(21) Appl. No.: 17/530,203

(22) Filed: Nov. 18, 2021

(51) Int. Cl. H04N 11/02; H04N 9/67; G06T 7/90; H04N 19/186; G06N 20/00

(52) U.S. Cl. CPC H04N 11/02; H04N 9/67; G06T 7/90; H04N 19/186; G06N 20/00; G06T 2207/20084; G06T 2207/10024; G06T 2207/10016

(57) ABSTRACT

Bandwidth for image transfer is reduced through color channel reduction. An image can be converted to a color space with a luminance channel, and the image can be decolorized by removing channels except for the luminance channel. Transmission of the image can subsequently be initiated across a network utilizing less bandwidth than the colorized image. Further, a model, such as a convolutional neural network, can be generated and shared over the network. The model is operable to colorize an image with missing channel information. After receiving the decolorized image, the model can be invoked to re-colorize the image based on luminance data and any color hints provided. The model can also produce a custom colorization for a display, a user, or both.

### BACKGROUND

A transition from working in offices to working from home has been occurring over the years. This trend has been expedited and exacerbated due to a pandemic where parents are working from home and children learning from home. Families are thus utilizing network resources to connect to work and school simultaneously. However, home networks typically have much less bandwidth than work or school networks. Less bandwidth and more connections beget unsatisfactory performance for users. For instance, video conferencing applications can experience poor video quality, such as pixelation, lag, or freezing.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, the subject disclosure pertains to reduced bandwidth image transfer. An image can be decolorized to decrease the size of the image. The image can be converted from a color space that does not provide a luminance channel to a color space that has a luminance channel. Color channels can be removed while preserving the luminance channel. Further, a machine learning model can be generated that is operable to recolor an image automatically. This model can be distributed or otherwise made available for use. The decolorized image can be transmitted over a network to a recipient computing device. The recipient computing device can invoke the model to re-colorize the image prior to rendering on a display of the computing device. The recipient computing device can optionally invoke a customized model for a particular display or user.

According to one aspect, a system is provided that comprises a processor coupled to a memory that includes instructions that, when executed by the processor, cause the processor to convert an image to a color space that includes a luminance channel, remove channels other than the luminance channel to decolorize the image, and initiate transmission of the image across a network. The instructions can further cause the processor to generate a model, such as a convolutional neural network, operable to colorize the image. The convolutional neural network can be customized for a display, user, or both. In one instance, the convolutional neural network is customized to compensate for color blindness of the user. The instructions can further cause the processor to make the model network accessible. The instructions can further cause the processor to download a copy of the model and invoke the model on an image. The instructions cause the processor to colorize a pixel in the image as a hint for subsequent colorization.

According to another aspect, a method is provided comprising generating a machine learning model trained to colorize an image, sharing the machine learning model over a network, converting an input image to a color space that includes a luminance channel, removing channels other than the luminance channel to decolorize the input image, and initiating transmission of the input image across the network. The method further comprises generating a convolutional neural network as the machine learning model to colorize the image. Further, the method comprises customizing the machine learning model for a display, user, or both. The method can further comprise colorizing a pixel in the image as a hint for subsequent colorization. Furthermore, the method comprises invoking the machine learning model on the image to colorize the input image.

In accordance with another aspect, a method is disclosed that executes, on a processor, instructions that cause the processor to perform operations. The operations include generating a convolutional neural network trained to colorize an image, sharing the convolutional neural network over a communication network, removing a color channel from a received image, and initiating transmission over a communication network. The operations further comprise converting the image to a color space that includes a luminance channel and removing channels other than the luminance channel from the received image. Further, the operations can comprise inserting a full-color pixel in the image to aid re-colorization. The operations can further comprise customizing the convolutional neural network for at least one of a display or user.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an overview of an example implementation.

FIG. 2 is a block diagram of an example compression system.

FIG. 3 is a block diagram of a sample color subtraction component.

FIG. 4 is a block diagram of a sample color addition component.

FIG. 5 is a flow chart diagram of a method of color-based image compression.

FIG. 6 is a flow chart diagram of a method of color-based image decompression.

FIG. 7 is a flow chart diagram of machine learning-based image transmission.

FIG. 8 is a block diagram illustrating a suitable operating environment for aspects of the subject disclosure.

### DETAILED DESCRIPTION

Full-color high-definition images or a sequence of images forming a video can be taxing on network bandwidth. In some instances, users can experience poor image or video quality, including lagging, freezing, or pixelation, among other things. Conventional image compression technologies can be utilized to reduce the size and bandwidth required to transmit images. Lossless compression seeks to compress images without destroying or altering any data such that when decompressed, the identical image is returned. Lossy compression can compress images to a smaller size, but some data is lost in exchange for the higher compression. The result is that a decompressed image has less data than the original image. However, the compression rate, in terms of size reduction, can vary significantly based on the compression technology and a particular image or video. Consequently, the impact on quality can be minimal when network bandwidth is constrained.

Details disclosed herein generally pertain to reduced bandwidth image transfer. Color spaces can include several channels representing primary colors that can be combined to produce additional colors, hues, and shades. Some color spaces also include additional channels, such as a luminosity channel that represents the brightness of an image. The number of channels can be subtracted to produce a smaller image or video for transmission over the network alone or in combination with conventional compression techniques. A receiving device can automatically reconstruct the image or video color channel information. In other words, stand-alone or supplemental lossy compression is disclosed.

Per one aspect, a color image can be converted to a color space with a luminance channel. All channels can be removed except the luminance channel. A decolorized version of the image comprising solely brightness information of the luminance channel can subsequently be transmitted over a network to a target device. A machine learning model, such as a convolutional neural network, can be trained to colorize an image using data from a luminance channel automatically. The model can be shared on a communication network. After receiving an image, the model can be invoked to recolor the image automatically. In one instance, the model can be customized for a particular display or user.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

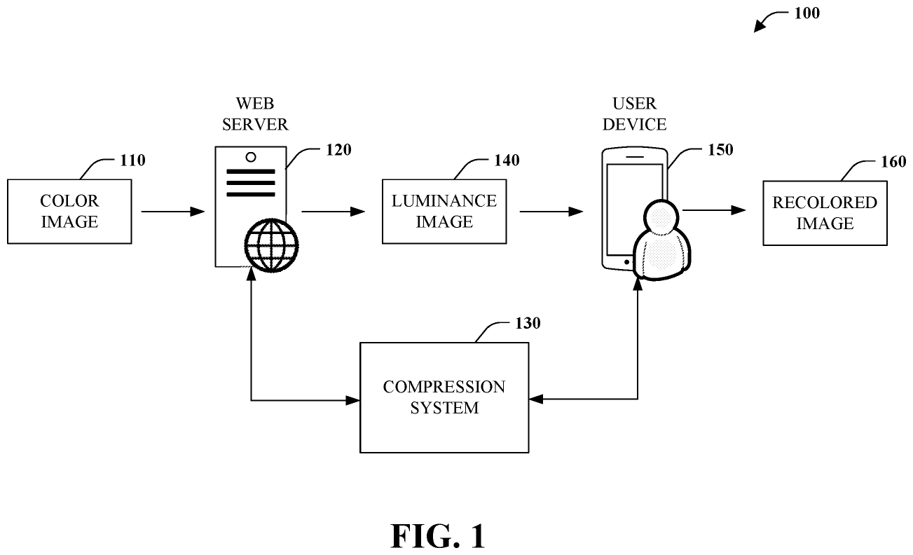

Referring initially to FIG. 1, a high-level overview of an example implementation 100 of reduced bandwidth image transfer is depicted. As shown, the implementation 100 includes color image 110, web server 120, compression system 130, luminance image 140, user device 150, and recolored image 160.

The color image 110 is a digital image produced by a camera in full color. In one instance, the color image 110 is one of a sequence of frames in a video. For example, the color image 110 can be a video frame associated with a video-conferencing application (e.g., Zoom, Teams, WebEx . . . ).

The web server 120 comprises software and underlying hardware that supports distribution of web pages and web services accessible through a web browser. For example, the web server 120 can provide a web page comprising a plurality of images or videos. Alternatively, the web server 120 can provide a service such as video conferencing that streams live video of participants. The web server 120 can employ functionality of the compression system 130 to compress images and video. Further, such compression can be performed before typical compression technologies.

The compression system 130 is operable to remove color data from the color image 110. In one instance, the compression system 130 can convert the color image 110 into a color space with a luminance channel if the current color space does not include a luminance channel. The compression system 130 can next decolorize the color image 110 by removing channels, except the luminance channel, to produce the luminance image 140. The luminance channel captures an amount of light emitted or reflected from a surface, which can also be termed brightness, for pixels of an image. Visually, the luminance image 140 can correspond to a grayscale image comprising shades of gray that range from black at the weakest intensity to white at the strongest.

The luminance image 140 can be transferred to the user device 150, for example, by way of the Internet and the world wide web. In response, the compression system 130 can be employed to generate the recolored image 160 for presentation on a display of the user device 150. More particularly, the compression system 130 can train a machine learning model, such as a convolutional neural network (CNN), to automatically recolor the luminance image to produce the recolored image 160. The model can be network accessible by the user device or stored locally on the user device 150. In accordance with one aspect, the model can be customized for a device, user, or both. For example, the model can be customized to produce the truest colors for a particular display device. Further, the model can be customized to adhere to user preference, including adjusting the image to compensate for the color blindness of a user.

The compression system 130 can be adjustable in terms of the rate of compression. In this way, a trade-off between accuracy and the recolored image and the amount of compression can be fine-tuned. For instance, the luminance image 140 can be generated to also include information regarding the color of one or more pixels that can provide a model hints regarding colors of particular elements of an image. The more pixel color data included, the larger the image will become, and the less pixel color data included, the smaller the image will be. Further, for videos, some frames can be colored while others are absent of color. In this case, prior and future frames in a sequence can be utilized to aid a model in recoloring frames. Control of the adjustment compression can be manual, semi-automatic, or automatic. For example, a user can manually set the compression rate or provide preferences that can be used to adjust automatically. In addition, the adjustment can be performed automatically based on bandwidth, current and predicted load or other factors. Further, adjustment can be performed in real or substantially real-time, such that compression of frames of a streaming video can be adjusted based on current or predicted reduction of available bandwidth.

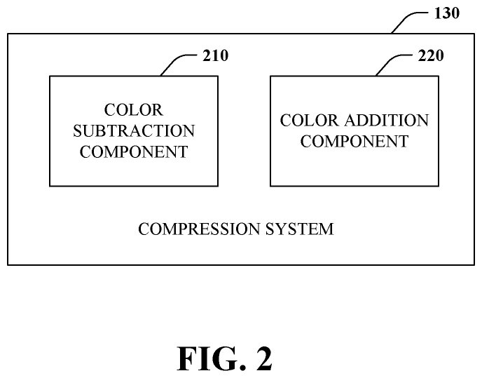

Turning attention to FIG. 2, an example compression system 130 is depicted in further detail. The compression system 130 includes color subtraction component 210 and color addition component 220. The color subtraction component 210 and the color addition component 220 can be implemented by a processor coupled to a memory that stores instructions that cause the processor to perform the functionality of each component when executed. Consequently, a computing device can be configured to be a special-purpose device or appliance that implements the functionality of the compression system 130. Further, portions of the compression system 130 can be distributed across computing devices or made accessible by way of a network service or data store.

The color subtraction component 210 is operable to remove color from a color image or video frame. The color subtraction component 210 can alter an input image to remove color or generate a new image with color excluded. A color space or a color model describes or organizes colors based on physics and human perception. The addition or subtraction of various primary colors identified by the space enables the representation of a plurality of colors. For example, a popular color model is RGB (Red, Green Blue), which includes red, green, and blue that are used in combination to obtain substantially any color in the visible spectrum (e.g., yellow, orange, purple . . . ). Color information for the primary colors of a model is stored in a color channel. For instance, in the RGB color space channels can exist for red, green, and blue. Other color models exist, including CMYK(Cyan, Magenta, Yellow, and Black) and LAB (Lightness, red/green, and blue/yellow). The color subtraction component 210 can remove one or more color channels for an image. In one instance, the color subtraction component 210 can remove all color channels resulting in an image captured by a luminosity channel. Removing color channels can reduce the size of the image and the bandwidth required to transport the image across a network. Further, the number of channels removed can be proportionate to the size reduction and required bandwidth occupied by an image. For example, removing three color channels results in a smaller image than removing one color channel.

The color addition component 220 is operable to add color to an image or video frame. In other words, the color addition component is the inverse of the color subtraction component 210. By way of example, for an RGB model, if the red color channel is missing, the color addition component 220 can be employed to rebuild the color channel. In accordance with one embodiment, a machine learning model can be generated to reconstruct omitted color channels. For instance, a convolutional neural network (CNN) can be trained to reconstruct color, including colorizing a decolorized image or video frame. Training data can comprise decolorized images and a fully colored image. The CNN can receive the decolorized images and seek to colorize the images. A comparison of a colorized image to a fully colored image can be employed to aid this process and model learning. As the model continues to learn over time, the difference between the re-colorized image and the original color image will decrease.

With a lossy model, the original color image will not be able to be reproduced exactly. However, a close approximation will be good enough as a trade-off for reduced size. Of course, an option can exist to replace a recolored image with an original colored image if the recolored image is unsatisfactory. Nevertheless, a customized machine-learning model can be generated for a particular display, user, or both to increase user satisfaction in the recolored image.

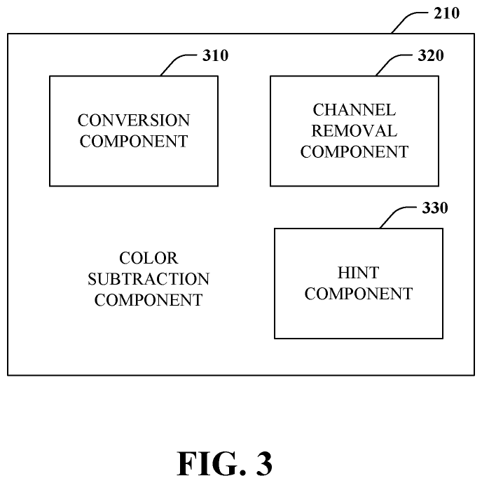

FIG. 3 is a block diagram of a sample color subtraction component 210. The color subtraction component 210 comprises conversion component 310, channel removal component 320, and hint component 330.

The conversion component 310 is operable to convert between color models or spaces. It may be desirable to remove chromatic or color channels and preserve an achromatic or luminance channel in one scenario. The luminance channel provides values for luminance, or brightness, for each pixel of an image. When displayed, an image with solely a luminance channel will appear as a grayscale image, where white represents high luminance and black represents low luminance. However, some color models or spaces do not include a luminance channel. Accordingly, the conversion component 310 can convert from a first color model to a second color model. The first color model does not include a luminance channel and the second color model includes a luminance channel. For example, an image in RGB or CMYK color models can be converted into a LAB color space that includes a luminance channel (“L”), red/green channel (“A”), and Blue/Yellow channel (“B”). The conversion can be performed by way of a mapping from one space to another.

The channel removal component 320 operably removes at least one chromatic or color channel from an image. Given an input image, color channels can be removed from the input image or copy of the input image. The removal of a color channel removes data regarding a color for pixels of the image. For example, a full-color image with an RGB color space will appear solely red if the green and blue color channels are removed. In one instance, the channel removal component 320 can remove all color channels leaving only a luminance channel to capture the image. In this case, all color will be removed, and the image will appear in grayscale, with white representing a high luminance and black corresponding to a low luminance.

The hint component 330 is operable to provide additional information or a hint regarding color for a color that has been removed by the channel removal component 320. For example, the color at a subset of pixels of an image can be captured by the image. This subset of color pixels provides a hint to subsequent colorization of a decolorized image. For instance, knowing a pixel is a specific color can allow re-colorization to extrapolate what other colors will look like, given the luminance for the pixel and surrounding pixels. Stated differently, a hint can improve the accuracy of re-colorization. The number of hints can be predetermined or automatically determined based on an image.

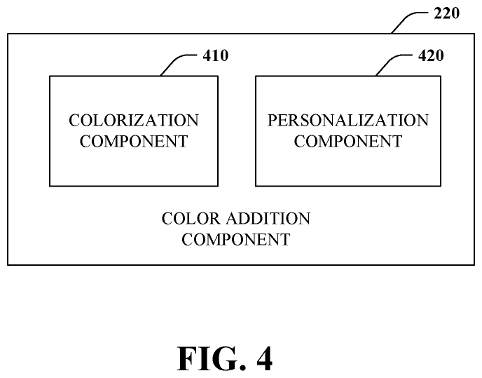

FIG. 4 depicts a sample color addition component 220. The color addition component 220 comprises colorization component 410 and personalization component 420.

The colorization component 410 is operable to add color to an image. In accordance with one aspect, at least one color channel can be removed from an image to reduce the size of the image and the bandwidth required to transport the image. All color channels can be removed in one particular instance, solely leaving an achromatic channel, such as a luminance channel. In one embodiment, a machine learning model, such as a convoluted neural network (CNN), can be generated and trained to colorize an image lacking full color. The machine learning model can be trained with training data that comprises images lacking color and full-color images. Through the training, data patterns can be learned such that generally, the grass is green, the sky is blue, and clouds are white. Further, the exact color of objects can be aided by any other information about an image. In one instance, an image can comprise a luminance channel solely. The machine learning model can be trained based on this channel to use luminance or brightness at each pixel to determine a particular color. For example, even if an element of an image is known or inferred to be blue, the luminance value can affect the shade of blue. If the luminance is high, the blue will be lighter (e.g., sky blue), whereas the blue (e.g., Navy blue) will be darker if the luminance is low (e.g., Navy blue). In accordance with one aspect, the image can include one or more hints regarding color. For instance, a subset of pixels can include full or partial color information. The machine learning model can use this information to extrapolate or otherwise infer surrounding colors based on the hint as well as luminance value at a point.

The personalization component 420 is operable to customize colorization of an image. The personalization component 420 operates over an output colorized image by the colorization component 410, or the personalization component 420 can be incorporated therein such that the colorization component 410 is personalized. In one instance, the personalization can be for a particular display device such as a smartphone, tablet screen, or desktop monitor. The size and capabilities of displays can be considered colorizing an image. Furthermore, the personalization component 420 can customize colorization for a particular user. Such customization can be a simple user preference. However, a user could be color blind and have difficulty discriminating between red and green hues in one instance. Accordingly, the personalization component 420 could render colors differently to allow a color blind individual to view the image more clearly. For example, the combination of red and green can be avoided, or the contrast for those colors can be increased.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished following either a push and/or pull control model. The components may also interact with one or more other components not specifically described herein for the sake of brevity but known by those of skill in the art.

Various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers, . . . ). Such components, among others, can automate certain mechanisms or processes performed thereby, making portions of the systems and methods more adaptive as well as efficient and intelligent. By way of example, and not limitation, the color addition component 220 can employ such mechanisms to determine or infer colors with which to colorize an image.

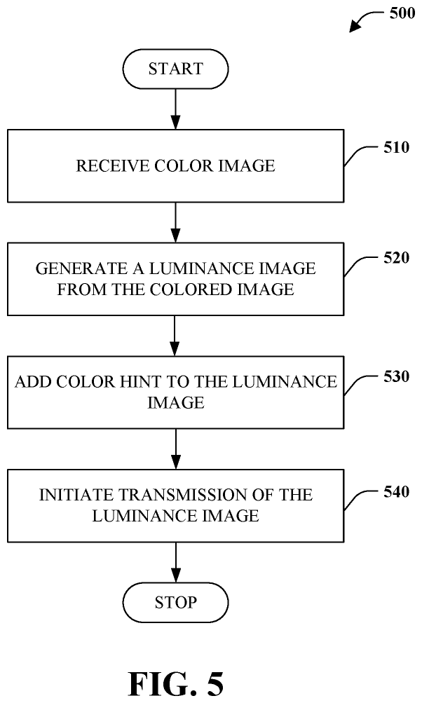

In view of the example systems described above, methods that may be implemented in accordance with the disclosed subject matter will be better appreciated with reference to flow chart diagrams of FIGS. 5-7. While for purposes of simplicity of explanation, the methods are shown and described as a series of blocks, it is to be understood and appreciated that the disclosed subject matter is not limited by order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 5, a method of color-based image compression 500 is depicted. The method 500 can be performed by the compression system 130 and, more particularly, the color subtraction component 210.

At reference numeral 510, a colored image is received, retrieved, or otherwise obtained or acquired. For instance, the image can correspond to a picture or photograph for display on a website. Alternatively, the image can correspond to one of a sequence of frames comprising a video, for example, associated with a video-conferencing application (e.g., Zoom, Teams WebEx . . . ).

At numeral 520, a luminance image is generated from the colored image. More specifically, color channels of the colored image can be removed from the colored image or a copy thereof, leaving solely the luminance channel. The luminance channel results in a grayscale version of the image, the luminance image, where white identifies areas of high luminosity or brightness and black indicates areas of low luminosity or brightness. If the image uses a color space that does not include a luminance channel or like achromatic channel, the color model or space can be changed to a model that includes the luminance channel. For example, a mapping can be performed between an RGB space and LAB space. After the color space conversion, a luminance image can be generated based on the luminance channel. Alternatively, one color channel can remain and be utilized to generate a luminance image, or here, a single color image representing luminance or brightness of pixels.

At reference numeral 530, a color hint is added to the luminance image. The hint can correspond to color data regarding a subset of one or more image pixels. For example, a pixel can include color associated with a color channel that was removed or all color channels, namely in full color. A hint can aid re-colorization of the image by providing a point from which color can be extrapolated or inferred for surrounding pixels based on the color and luminance values. The number of hints, or colored pixels, can be predetermined and manually specified or determined automatically or semi-automatically based on the image, desired compression, or accuracy sought.

At numeral 540, transmission of the luminance image can be initiated. For example, the image can form part of a web page, video frame, or application transmitted over the Internet from a web server to a client device browser.

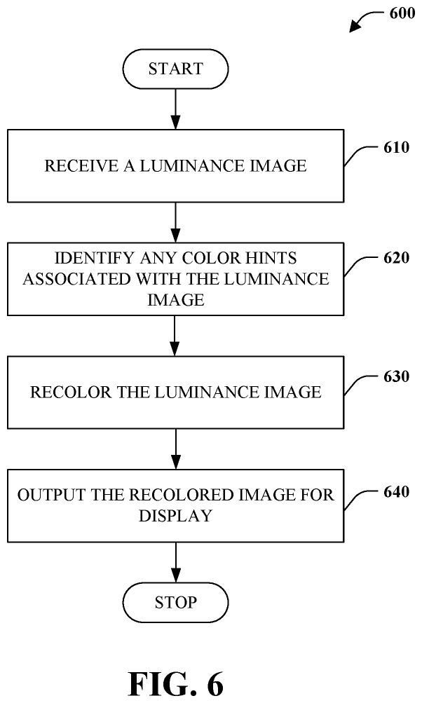

FIG. 6 illustrates a method 600 of color-based image decompression. The method 600 can be performed by the compression system 130 and, more particularly, the color addition component 220.

At reference numeral 610, a luminance image is received, retrieved, or otherwise obtained or acquired. The luminance image is an image comprising a luminance channel with one or all color channels removed. The luminance image can be transmitted over any network, for instance, from a server to a client device or vice versa.

At numeral 620, the luminance image is analyzed to determine the presence or absence of any color hints associated with the image. Color hints can comprise one or more pixels transmitted in full or partial color within the image that channels except the luminance channel. The hints can be provided within the image itself or as part of metadata associated with the image. The number of hints, if any at all, can vary. The analysis thus seeks to identify all hints concerning the image.

At numeral 630, the image is recolored. In accordance with one aspect, a machine learning model, such as a convolutional neural network (CNN), can be invoked to recolor the image. The model can be trained on data associated with image coloring utilizing luminance channel data. For example, an object or element of an image can be identified. Known or learned color of such an object, such as grass, the sky, and clouds, and the luminance data can be utilized to select a shade of such color for image pixels corresponding to the object. Further, the model can be trained to utilize color hints to extrapolate or infer the color of surrounding pixels as well as the image as a whole. In one instance, the model can be customized or personalized for a display device, a user, or both. For example, the model can increase the contrast between red and green for a color-blind user.

At reference numeral 640, the recolored image is output for display on a display device. For example, the recolored image can be displayed on a smartphone, laptop, or tablet screen. In one instance, the recolored image can correspond to a video associated with a video-conferencing application. Accordingly, the image can be recolored before it is displayed.

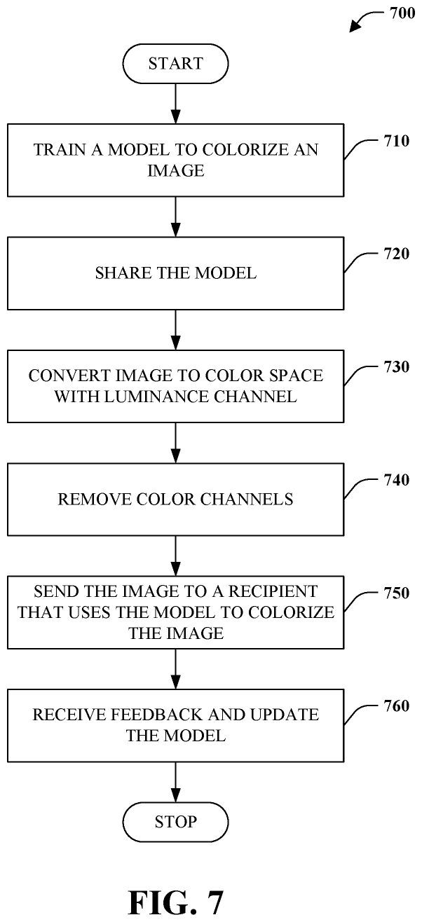

FIG. 7 is a flow chart diagram of a method 700 of machine-learning-based image transmission. The method can be implemented by the compression system 130, and more particularly, the color addition component 220.

At reference numeral 710, a model is trained to colorize an image. The model can correspond to a machine learning model, such as a convolutional neural network. Training data can include images with a luminance channel and one or more removed color channels, and a full-color image. The model can learn color associated with particular objects or elements of an image at a particular brightness or luminance. In one instance, the model can also learn how to extrapolate or infer image color based on color hints comprising one or more pixels of full or partial color.

At reference numeral 720, the generated and trained model is shared or otherwise made available or accessible. The model can be shared with entities to allow the re-colorization of images. In one particular instance, the model can be shared with a program, such as a video conferencing application or service, that employs image compression as described herein to enable decompression. The model can be shared with a particular user and client device in a situation in which the model is customized for the user or device.

At numeral 730, the color space of an image is converted to a color space with a luminance channel. The color space of an image can first be determined. If the color space includes a luminance channel, this step can be skipped. If the color space does not include a luminance channel, the image can be converted to a color space or model that includes a luminance channel. This conversion can be performed by a mapping from a first model to a second model. For example, an image with an RGB color space or model can be converted to a LAB color space or model image.

At numeral 740, color channels are removed from the image. In one instance, all color channels are removed from an image with solely the luminance channel remaining. Of course, a subset of colors can be removed. Further, color channels can be removed, but a pixel in the image can retain the color as a hint for re-colorization.

At reference numeral 750, the image is sent to a recipient. The recipient can utilize the model to colorize the image. For instance, the model can be invoked on an image comprising a luminance channel and return a full-color image. Furthermore, any color hints included in the image can aid in accurate colorization, for example, by extrapolating or inferring colors based on the color hint and luminance values.

At numeral 760, feedback can be received regarding performance of the model. For instance, feedback can be solicited regarding the quality of the recolored image from a user. Additionally, or alternatively, the recolored image can be compared to a color image before the removal of color channels. Such feedback can then be utilized to update the model and improve future performance.

The subject disclosure pertains to the technical problem of limited bandwidth transfer of images resulting in pixelation, lag, or freezing. The technical solution comprises compression of images that removes chromatic channels while preserving an achromatic channel. A machine learning model can be trained and invoked to decompress or recolor an image. In one instance, a machine learning model can be customized for a display, user, or both. For example, a model can generate an image with increased contrast between red and green colors of an image for a color-blind user.

Color based image compression is disclosed herein. This compression can be performed prior to conventional image compression techniques to further reduce the size of the image and therefor the bandwidth required to transfer the image. Prior to sending the color based image compression can be performed followed by a conventional image compression technique. After receipt, a recipient device can decompress the image utilizing the inverse of the conventional image compression technique employed. Subsequently, image re-colorization can be performed to generate a color version of the image.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be but is not limited to being a process running on a processor, a processor, an object, an instance, an executable, a thread of execution, a program, and/or a computer. By way of illustration, both an application running on a computer and the computer can be a component. One or more components may reside within a process and/or thread of execution, and a component may be localized on one computer and/or distributed between two or more computers.

As used herein, the term “infer” or “inference” generally refer to the process of reasoning about or inferring states of a system, a component, an environment, or a user from one or more observations captured by way of events or data, among other things. Inference may be employed to identify a context or an action or may be used to generate a probability distribution over states, for example. An inference may be probabilistic. For example, computation of a probability distribution over states of interest can be based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several events and data sources.

The conjunction “or” as used in this description and appended claims is intended to mean an inclusive “or” rather than an exclusive “or,” unless otherwise specified or clear from the context. In other words, ′″X′ or ′Y′″ is intended to mean any inclusive permutations of “X” and “Y.” For example, if ′″A′ employs ′X,′″ ′″A employs ′Y,′″ or ′″A′ employs both ‘X’ and ′Y,′″ then ′″A′ employs ‘X’ or ′Y′″ is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

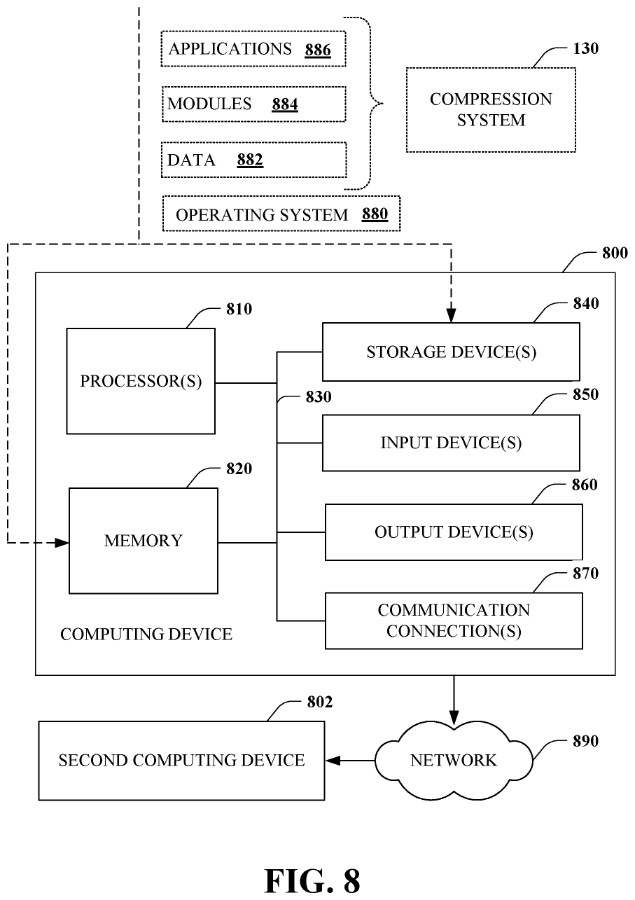

To provide a context for the disclosed subject matter, FIG. 8, as well as the following discussion, are intended to provide a brief, general description of a suitable environment in which various aspects of the disclosed subject matter can be implemented. However, the suitable environment is solely an example and is not intended to suggest any limitation on scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules may be located in one or both of local and remote memory devices.

With reference to FIG. 8, illustrated is an example computing device 800 (e.g., desktop, laptop, tablet, watch, server, hand-held, programmable consumer or industrial electronics, set-top box, game system, compute node, . . . ). The computing device 800 includes one or more processor(s) 810, memory 820, system bus 830, storage device(s) 840, input device(s) 850, output device(s) 860, and communications connection(s) 870. The system bus 830 communicatively couples at least the above system constituents. However, the computing device 800, in its simplest form, can include one or more processors 810 coupled to memory 820, wherein the one or more processors 810 execute various computer-executable actions, instructions, and or components stored in the memory 820.

The processor(s) 810 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 810 may also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 810 can be a graphics processor unit (GPU) that performs calculations concerning digital image processing and computer graphics.

The computing device 800 can include or otherwise interact with a variety of computer-readable media to facilitate control of the computing device to implement one or more aspects of the disclosed subject matter. The computer-readable media can be any available media accessible to the computing device 800 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid-state devices (e.g., solid-state drive (SSD), flash memory drive (e.g., card, stick, key drive . . . ) . . . ), or any other like mediums that store, as opposed to transmit or communicate, the desired information accessible by the computing device 800. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 820 and storage device(s) 840 are examples of computer-readable storage media. Depending on the configuration and type of computing device, the memory 820 may be volatile (e.g., random access memory (RAM)), non-volatile (e.g., read only memory (ROM), flash memory . . . ), or some combination of the two. By way of example, the basic input/output system (BIOS), including basic routines to transfer information between elements within the computing device 800, such as during start-up, can be stored in non-volatile memory, while volatile memory can act as external cache memory to facilitate processing by the processor(s) 810, among other things.

The storage device(s) 840 include removable/non-removable, volatile/non-volatile storage media for storage of vast amounts of data relative to the memory 820. For example, storage device(s) 840 include, but are not limited to, one or more devices such as a magnetic or optical disk drive, floppy disk drive, flash memory, solid-state drive, or memory stick.

Memory 820 and storage device(s) 840 can include, or have stored therein, operating system 880, one or more applications 886, one or more program modules 884, and data 882. The operating system 880 acts to control and allocate resources of the computing device 800. Applications 886 include one or both of system and application software and can exploit management of resources by the operating system 880 through program modules 884 and data 882 stored in the memory 820 and/or storage device(s) 840 to perform one or more actions. Accordingly, applications 886 can turn a general-purpose computer 800 into a specialized machine in accordance with the logic provided thereby.

All or portions of the disclosed subject matter can be implemented using standard programming and/or engineering techniques to produce software, firmware, hardware, or any combination thereof to control the computing device 800 to realize the disclosed functionality. By way of example and not limitation, all or portions of the compression system 130 can be, or form part of, the application 886, and include one or more modules 884 and data 882 stored in memory and/or storage device(s) 840 whose functionality can be realized when executed by one or more processor(s) 810.

In accordance with one particular embodiment, the processor(s) 810 can correspond to a system on a chip (SOC) or like architecture including, or in other words integrating, both hardware and software on a single integrated circuit substrate. Here, the processor(s) 810 can include one or more processors as well as memory at least similar to the processor(s) 810 and memory 820, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the compression system 130 and/or functionality associated therewith can be embedded within hardware in a SOC architecture.

The input device(s) 850 and output device(s) 860 can be communicatively coupled to the computing device 800. By way of example, the input device(s) 850 can include a pointing device (e.g., mouse, trackball, stylus, pen, touchpad, . . . ), keyboard, joystick, microphone, voice user interface system, camera, motion sensor, and a global positioning satellite (GPS) receiver and transmitter, among other things. The output device(s) 860, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 850 and output device(s) 860 can be connected to the computing device 800 by way of wired connection (e.g., bus), wireless connection (e.g., Wi-Fi, Bluetooth, . . . ), or a combination thereof.

The computing device 800 can also include communication connection(s) 870 to enable communication with at least a second computing device 802 utilizing a network 890. The communication connection(s) 870 can include wired or wireless communication mechanisms to support network communication. The network 890 can correspond to a local area network (LAN) or a wide area network (WAN) such as the Internet. The second computing device 802 can be another processor-based device with which the computing device 800 can interact. In one instance, the computing device 800 can correspond to a web server that executes the compression system 130 to decolorize an image to reduce transmission bandwidth. The second computing device 802 can correspond to a user device that receives a decolorized image and employs a local or network-accessible machine learning model to re-colorize the image before presentation on a display of the user device.

What has been described above includes examples of aspects of the claimed subject matter. It is, of course, not possible to describe every conceivable combination of components or methodologies for purposes of describing the claimed subject matter. However, one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to a memory that includes instructions that, when executed by the processor, cause the processor to:
convert an image to a color space that includes a luminance channel;
remove channels other than the luminance channel to decolorize the image; and
initiate transmission of the image across a network.

2. The system of claim 1, wherein the instructions further cause the processor to generate a model operable to colorize the image.

3. The system of claim 2, wherein the model is a convolutional neural network.

4. The system of claim 3, wherein the convolutional neural network is customized for a display.

5. The system of claim 3, wherein the convolutional neural network is customized for a user.

6. The system of claim 5, wherein the convolutional neural network is customized to compensate for color blindness of the user.

7. The system of claim 2, wherein the instructions further cause the processor to make the model network accessible.

8. The system of claim 4, wherein the instructions further cause the processor to download a copy of the model.

9. The system of claim 5, wherein the instructions further cause the processor to invoke the model on the image.

10. The system of claim 1, wherein the instructions further colorize a pixel in the image as a hint for subsequent colorization.

11. A method, comprising:
generating a machine learning model trained to colorize an image;
sharing the machine learning model over a network;
converting an input image to a color space that includes a luminance channel;
removing channels other than the luminance channel to decolorize the input image; and
initiating transmission of the input image across the network.

12. The method of claim 11, further comprising generating a convolutional neural network as the machine learning model to colorize the image.

13. The method of claim 11, further comprising customizing the machine learning model for a display.

14. The method of claim 11, further comprising customizing the machine learning model for a user.

15. The method of claim 11, further comprising colorizing a pixel in the image as a hint for subsequent colorization.

16. The method of claim 11, further comprising invoking the machine learning model on the image to colorize the input image.

17. A method of reduced bandwidth image transfer, comprising:
executing, on a processor, instructions that cause the processor to perform operations, the operations comprising:
generating a convolutional neural network trained to colorize an image;
sharing the convolutional neural network over a communication network;
removing a color channel from a received image; and
initiating transmission of the received image over a communication network.

18. The method of claim 17, wherein the operations further comprise:
converting the image to a color space that includes a luminance channel; and
removing channels other than the luminance channel from the received image.

19. The method of claim 17, wherein the operations further comprise inserting a full-color pixel in the image to aid re-colorization.

20. The method of claim 17, wherein the operations further comprise customizing the convolutional neural network for at least one of a display or user.
